(19) United States
(12) Patent Application Publication
(10) Pub. No.: US 2017/0069434 A1
(43) Pub. Date: Mar. 9, 2017

(54) Hybrid Supercapacitor

(71) Applicant: Robert Bosch GmbH, Stuttgart (DE)

(72) Inventors: Pallavi Verma, Leinfelden (DE); Michael Donotek, Asperg (DE); Severin Hahn, Maegenwil (CH); Tobias Schonhardt, Voerstetten (DE); Elisabeth Buehler, Tamm (DE)

(21) Appl. No.: 15/251,037

(22) Filed: Aug. 30, 2016

(30) Foreign Application Priority Data
Sep. 4, 2015 (DE) 10 2015 216 955.3
Dec. 2, 2015 (DE) 10 2015 224 094.0

(51) Int. Cl. H01G 11/60; H01G 11/46; H01G 11/06; H01G 11/62

(52) U.S. Cl. CPC H01G 11/60; H01G 11/62; H01G 11/46; H01G 11/06

(57) ABSTRACT

A hybrid supercapacitor includes an anode and a cathode. The cathode is applied to a first collector, and the anode is applied to a second collector. The hybrid supercapacitor also includes an electrolyte that is inserted between the anode and the cathode. The electrolyte contains an ionic liquid as a solvent.

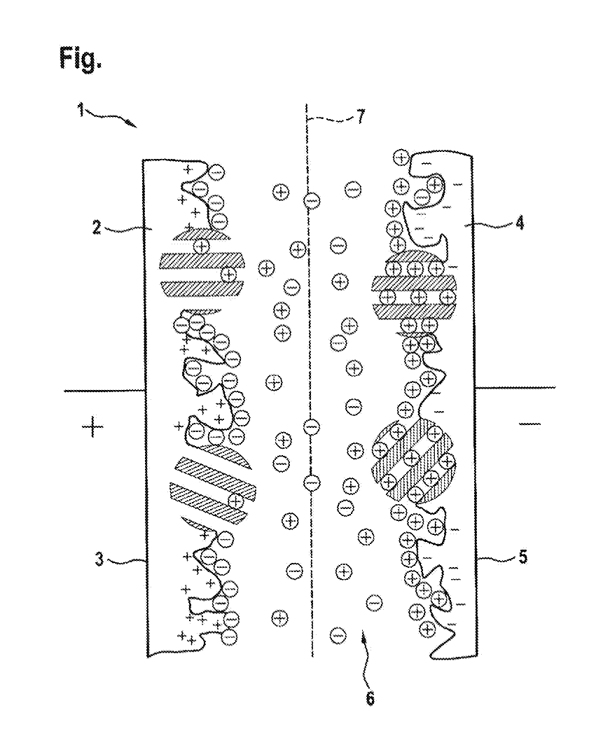

This application claims priority under 35 U.S.C. §119 to patent application numbers DE 10 2015 216 955.3, filed in Germany on Sep. 4, 2015, and DE 10 2015 224 094.0, filed in Germany on Dec. 2, 2015, the disclosures of which are incorporated herein by reference in their entireties.

### BACKGROUND

The disclosure relates to a hybrid supercapacitor. The disclosure further relates to the use of an ionic liquid as solvent in the electrolyte of the hybrid supercapacitor.

Hybrid supercapacitors (Hybrid Super Capacitors—HSCs), for example lithium ion capacitors, represent a new generation of supercapacitors which can provide more power than lithium ion batteries. Although lithium ion batteries have a high energy density of more than 100 Wh/kg, they can release this energy only slowly. Hybrid supercapacitors have a higher energy density than supercapacitors (EDLCs/SCs), which can provide a power output of more than 100 kW/kg but have only a low energy density. Hybrid supercapacitors can, for example, be charged by means of short high-energy pulses as occur in braking energy recuperation in motor vehicles. The electric energy recovered in this way can subsequently be used to accelerate the motor vehicle. It makes a saving of fuel and a reduction in carbon dioxide emissions possible. Hybrid supercapacitors are also being taken into consideration for use as energy source in electric tools. Since hybrid supercapacitors represent a new technology compared to conventional supercapacitors and lithium ion batteries, there are only few products commercially available at present. In fields of application which would be suitable for hybrid supercapacitors, use is usually made of overdimensioned lithium ion batteries which owing to their size are able to provide the power required in each case for the application concerned.

Hybrid supercapacitors can be divided into two different categories, depending on the cell structure: symmetric and asymmetric hybrid supercapacitors. Asymmetric hybrid supercapacitors have an electrode whose material stores energy by a reversible Faraday reaction. This can be a hybridized electrode. The second electrode is purely capacitive, i.e. it stores energy by formation of a Helmholz double layer. This structure is customary for, in particular, hybrid supercapacitors of the first generation since it has an electrode configuration which corresponds to the structure of lithium ion battery electrodes or supercapacitor electrodes, so that known electrode production processes can be utilized. Lithium ion capacitors are an example of an asymmetric hybrid supercapacitor. Here, lithiated graphite or another form of lithiated carbon is used as anode. This makes a maximum voltage window of up to 4.3 V possible. However, SEI (Solid Electrolyte Interface) formation at the anode is unavoidable when using anode materials having an intercalation potential close to 0 V vs. Li/Li⁺, for example graphite. This is usually countered by targeted cell modification, e.g. by means of electrolyte additives such as vinylene carbonate, in order to stabilize the SEI layer and prevent further electrolyte decomposition. The second type are symmetric hybrid supercapacitors which consist of two internally hybridized electrodes having both Faraday materials and capacitively active materials. This combination allows the power density of hybrid supercapacitors to be considerably increased compared to conventional lithium ion batteries or the energy density to be considerably increased compared to conventional supercapacitors. Furthermore, synergistic effects between the two active electrode materials in the two electrodes can be utilized. In addition, carbon as electrode constituent makes more rapid energy provision from the two electrodes possible since it improves the electrical conductivity of the electrodes. Highly porous carbon can also function as shock absorber for high currents. Symmetric hybrid supercapacitors are superior to asymmetric hybrid supercapacitors in pulsed operation.

It is stated in D. Cericola, P. Novak, A. Wokaun, R. Kötz, Journal of Power Sources 2011, 196 (23) 10305-10313, that a solution of a lithium salt in acetonitrile as electrolyte is usually employed in symmetric hybrid supercapacitors. However, acetonitrile can be used only in a voltage window of 3.5 V. Particularly in electrodes which contain activated carbon, as is the case in symmetric hybrid supercapacitors, the voltage window is limited to 2.7 V. This limits the achievable energy density of activated carbon and of lithium oxides as electrode materials. This is due, in particular, to the electric energy which can be stored in activated carbon increasing linearly with the voltage. In addition, the limited voltage window restricts the selection of usable cathode materials. Acetonitrile has the further disadvantages that it is inflammable and has a high vapor pressure. This can lead to evaporation with formation of toxic hydrocyanic acid. Furthermore, acetonitrile has a boiling point of 82° C., which prevents its use in high-temperature applications.

### SUMMARY

The hybrid supercapacitor of the disclosure is, in particular, configured as a symmetric hybrid supercapacitor. It has an electrolyte which contains an ionic liquid as solvent. Ionic liquids have a wider voltage window than acetonitrile, which leads to an increased energy density at the electrodes of the hybrid supercapacitor. In addition, ionic liquids have virtually no vapor pressure and are therefore noncombustible. The long life of conventional hybrid supercapacitors is not reduced by the use of ionic liquids in their electrolytes. In addition, they can, in particular, be operated at high temperatures up to 120° C. as a result of the use of ionic liquids.

The ionic liquid is preferably selected from the group consisting of 1-butyl-3-methylpyrrolidinium hexafluorophosphate (BMIM PF₆), 1-butyl-1-methylpyrrolidinium bis(trifluoromethylsulfonyl)imide, 1-ethyl-1-methyl-pyrrolidinium thiocyanate (EMIM SCN) and mixtures thereof. The ionic liquid is also preferably selected from the group consisting of the ions in table 1 “Cations and Anions”, Physical Properties of Ionic Liquids: Database and Evaluation, Zhang et al, J. Phys. Chem. Ref. Data, Vol. 35, No. 4, 2006 and mixtures thereof. It has been found that these ionic liquids in each case have a voltage window of at least 5 V.

In addition to the ionic liquid, the electrolyte preferably comprises at least one further solvent which is not an ionic liquid. This solvent is particularly preferably selected from the group consisting of acetonitrile, propylene carbonate, γ-butyrolactone and mixtures thereof. The addition of a further solvent makes it possible to reduce the viscosity of the solvent mixture, which leads to a higher ionic conductivity of the electrolyte.

The electrolyte contains an electrolyte salt in addition to the solvent. The anion of the electrolyte salt preferably corresponds to the anion of the ionic liquid. This makes particularly good solubility of the electrolyte salt in the ionic liquid possible.

A suitable concentration of the electrolyte salt in the electrolyte is, in particular, in the range from 0.8 mol/l to 1.0 mol/l.

In order to increase the ionic conductivity of the electrolyte, it can also contain at least one further electrolyte salt whose anion does not correspond to the anion of the ionic liquid in addition to the electrolyte salt whose anion corresponds to the anion of the ionic liquid. This further electrolyte salt is, in particular, selected from the group consisting of tetramethylammonium tetrafluoroborate (N(CH₄)₄BF₄), lithium perchlorate (LiClO₄), lithium hexafluorophosphate (LiPF₆), lithium tetrafluoroborate (LiBF₄), lithium bistrifluoromethanesulfonimide ((LiN(SO₂CF₃)₂, LiTFSi), lithium bisfluorosulfonylimide (LiN(SO₂F)₂, LiFSi), lithium bisoxalatoborate (LiB(C₂O₄)₂, LiBOB), lithium oxalyldifluoroborate (LiBF₂(C₂O₄), LiODFB), lithium fluoroalkylphosphate (LiPF₃(CF₃CF₂)₃, LiFAP), lithium trifluoromethanesulfonate (LiCF₃SO₃) and lithium bispentafluoroethanesulfonimide (LiN(SO₂C₂F₅)₂).

The cathode of the hybrid supercapacitor preferably contains LiMn_{1.5}Ni_{0.5}O₄ and/or LiCoPO₄. These lithium compounds allow particularly advantageous operation of a hybrid supercapacitor at high voltages. However, this property can be utilized only in combination with an ionic liquid as electrolyte solvent. In a hybrid supercapacitor containing acetonitrile as solvent of the electrolyte, the use of these cathode materials would, in contrast, not bring about any advantages. However, other redox materials can in principle also be used as constituents of the electrode of the hybrid supercapacitor.

The LiMn_{1.5}Ni_{0.5}O₄ and/or LiCoPO₄ forms, particularly in the manner known for hybrid supercapacitors in the case of other cathode materials, a composite material with an EDLC (Electric Double Layer Charging) material.

The hybrid supercapacitor as an anode in addition to its cathode. The anode preferably contains Li₄Ti₅O₁₂ which, in the manner known for the electrodes of hybrid supercapacitors in the prior art, forms a composite material with an EDLC material. This lithium titanate oxide has already been found to be useful as anode material in hybrid supercapacitors and it has now been found that it can also advantageously be used in combination with an electrolyte containing an ionic liquid.

The EDLC material of the composite material of the cathode and/or of the composite material of the anode is preferably present as carbon in a modification selected from the group consisting of activated carbon, graphene, carbon nanotubes, carbon aerogels, carbon nanofibers and mixtures thereof. The carbon nanotubes can be single-wall nanotubes or multiwall nanotubes in which a plurality of single-wall nanotubes are nested coaxially within one another. The diameter of the carbon nanotubes is, in particular, in the range 1-3 nm The carbon nanofibers can be spun to give flexible woven fabrics which, in particular, have pores having a diameter of less than 2 nm The high surface area of these carbon materials allows advantageous embedding of LiMn_{1.5}Ni_{0.5}O₄ and/or LiCoPO₄ and/or Li₄Ti₅O₁₂.

If the hybrid supercapacitor is configured as an asymmetric hybrid supercapacitor, its unhybridized electrode can, in particular, consist of one of the EDLC materials mentioned. As an alternative, it can consist, in particular, of a material selected from the group consisting of ruthenium oxide, manganese oxide, titanium oxide, polyaniline (PANI), polypyrrole (Ppy) and mixtures thereof with EDLC materials.

The use of an ionic liquid as solvent in the electrolyte of a hybrid supercapacitor leads to an increase in the energy density of the hybrid supercapacitor compared to hybrid supercapacitors having conventional electrolyte solvents.

### BRIEF DESCRIPTION OF THE DRAWINGS

The FIGURE schematically shows the structure of a symmetric hybrid supercapacitor as per a working example of the disclosure.

### DETAILED DESCRIPTION

A hybrid supercapacitor 1 as per the working example of the disclosure has the structure shown in the FIGURE. A cathode 2 has been applied to a first collector 3. An anode 4 has been applied to a second collector 5. An electrolyte 6 has been inserted between the cathode 2 and the anode 4. A separator 7 separates the cathode 2 from the anode 4. Embedding of Li⁺ ions in the cathode 2 and in the anode 4 is shown schematically in four enlargements in the FIGURE.

The cathode 2 consists of a 150 μm thick layer of a material containing activated carbon and LiMn_{1.5}Ni_{0.5}O₄ together with polytetrafluoroethylene as binder. The anode 4 consists of a 150 μm thick layer of a material containing Li₄Ti₅O₁₂ together with polytetrafluoroethylene as binder. A 0.9 M solution of lithium hexafluorophosphate in 1-butyl-3-methylpyrrolidinium hexafluorophosphate is used as electrolyte 6. The separator 7 consists of a porous woven aramid fabric.

In a solid-state cyclovoltammogram, Faraday Li⁺ intercalation reactions and Li⁺ deintercalation reactions were determined as a potential of 4.9 V relative to Li/Li⁺ for the LiMn_{1.5}Ni_{0.5}O₄ of the cathode. For the Li₄Ti₅O₁₂ of the anode, Faraday Li⁺ intercalation reactions and Li⁺ deintercalation reactions were determined at a potential of 1.5 V relative to Li/Li⁺. The electrolyte solution is stable up to a potential of 5 V relative to Li/Li⁺. The symmetric hybrid supercapacitor 1 can thus be operated in a voltage window of from 0 to 3.4 V.

What is claimed is:

1. A hybrid supercapacitor, comprising:
a cathode;
an anode; and
an electrolyte between the cathode and the anode, the electrolyte containing an ionic liquid as a solvent.

2. The hybrid supercapacitor according to claim 1, wherein the ionic liquid is selected from the group consisting of 1-butyl-3-methylpyrrolidinium hexafluorophosphate, 1-butyl-1-methylpyrrolidinium bis(trifluoromethylsulfonyl)imide, 1-ethyl-1-methylpyrrolidinium thiocyanate, and mixtures thereof.

3. The hybrid supercapacitor according to claim 1, wherein the electrolyte contains at least one further solvent which is not an ionic liquid.

4. The hybrid supercapacitor according to claim 3, wherein the further solvent is selected from among acetonitrile, propylene carbonate, γ-butyrolactone, and mixtures thereof.

5. The hybrid supercapacitor according to claim 1, wherein:
the electrolyte contains an electrolyte salt; and
an anion of the electrolyte salt corresponds to an anion of the ionic liquid.

6. The hybrid supercapacitor according to claim 5, wherein a concentration of the electrolyte salt in the electrolyte is between 0.8 mol/l and 1.0 mol/l.

7. The hybrid supercapacitor according to claim 5, wherein:
the electrolyte contains at least one further electrolyte salt; and
an anion of the electrolyte salt does not correspond to an anion of the ionic liquid.

8. The hybrid supercapacitor according to claim 7, wherein the further electrolyte salt is selected from the group consisting of tetramethylammonium tetrafluoroborate, lithium perchlorate, lithium hexafluorophosphate, lithium tetrafluoroborate, lithium bistrifluoromethanesulfonimide, lithium bisfluorosulfonylimide, lithium bisoxalatoborate, lithium oxalyldifluoroborate, lithium fluoroalkylphosphate, lithium trifluoromethanesulfonate, and lithium bispentafluoroethanesulfonimide

9. The hybrid supercapacitor according to claim 1, wherein the cathode contains at least one of LiMn_{1.5}Ni_{0.5}O₄ and LiCoPO₄.

10. Use of an ionic liquid as a solvent in an electrolyte of a symmetric hybrid supercapacitor.
